(19) United States
(12) Patent Application Publication
(10) Pub. No.: US 2024/0198587 A1
(43) Pub. Date: Jun. 20, 2024

(54) Systems and Methods for Releasing a Membrane in Resin 3-D Printing

(71) Applicant: BMF Material Technology Inc., Shenzhen (CN)

(72) Inventor: Chunguang Xia, San Diego, CA (US)

(73) Assignee: BMF Material Technology Inc., Shenzhen (CN)

(21) Appl. No.: 18/287,429

(22) PCT Filed: Apr. 11, 2022
(86) PCT No.: PCT/IB2022/053395

§ 371 Date: Oct. 18, 2023

Related U.S. Application Data
(60) Provisional application No. 63/176,716, filed on Apr. 19, 2021.

(51) Int. Cl. B29C 64/245; B29C 64/129; B29C 64/25; B29C 64/264; B33Y 10/00; B33Y 30/00

(52) U.S. Cl. CPC B29C 64/245; B29C 64/129; B29C 64/25; B29C 64/264; B33Y 10/00; B33Y 30/00

(57) ABSTRACT

A 3-D printing system includes a membrane configured to releasably retain a print sample thereon, a membrane release slidably supported on a portion of the membrane, and a vacuum source. The membrane release includes a housing defining a cavity within an interior portion thereof, a first roller rotatably supported within a portion of the cavity of the housing and rotatably disposed on a first portion of the membrane, and a second roller rotatably supported within a portion of the cavity of the housing in spaced relation from the first roller and forming a gap therebetween. The second roller is rotatably disposed on a second portion of the membrane and the vacuum source is in fluid communication with the cavity of the housing such that the application of a vacuum to the cavity effectuates a corresponding deformation of the membrane between the first and second rollers.

### TECHNICAL FIELD

The present disclosure relates to additive manufacturing, and more particularly, systems and methods for releasing a membrane in resin 3-D printing.

### BACKGROUND

Stereolithography was originally conceived as a rapid prototyping technology and refers to a family of technologies that are used to create true-scale models of production components directly from computer aided design (CAD) in a rapid (faster than before) manner. Since its conception, and through its disclosure in U.S. Pat. No. 4,575,330, stereolithography has greatly aided engineers, in addition to many others, in visualizing complex three-dimensional part geometries, detecting errors in prototype schematics, testing critical components, and verifying theoretical designs at relatively low costs and much improved time frames.

During the past decades, continuous improvements in the field of micro-electromechanical systems (MEMS) have led to the emergence of micro-stereolithography (μSL), which inherits basic principles from traditional stereolithography but with much high spatial resolution, as described by K. Ikuta and K. Hirowataris in “Real Three Dimensional Micro Fabrication Using Stereo Lithography and Metal Molding,” 6^{th} IEEE Workshop on Micro Electrical Mechanical Systems, 1993. Aided by single-photon polymerization and two-photon polymerization techniques, the resolution of μSL was further enhanced to be less than 200 nm, as described by S. Maruo and K. Ikuta in “Three-dimensional Microfabrication by Use of Single-photon-absorbed Polymerization,” Appl. Phys. Lett., vol. 76, 2000 and “Two-Photon-Absorbed Near-Infrared Photopolymerization for Three-dimensional Microfabrication,” J. MEMS, vol. 7, pp. 411, and as described by S. Kawata, H. B. Sun, T. Tanaka, and K. Takada in “Finer Features for Functional Microdevices,” Nature, vol. 412, pp. 697, 2001.

The speed of μSL was dramatically increased with the development of projection micro-stereolithography (PμSL), as described by Bertsch et al. in “Microstereophotolithography using a Liquid Crystal Display as Dynamic Mask-Generator,” Microsystem Technologies, pp. 42-47, 1997 and by Beluze et al. in “Microstereolithography: A New Process to Build Complex 3D Objections, Symposium on Design, Test and Microfabrication of MEMs/MOEMs,” Proceedings of SPIE, v3680, n2, pp. 808-817, 1999. The core of this technology is a high resolution spatial light modulator, which is either a liquid crystal display (LCD) panel or a digital light processing (DLP) panel, each of which are available from micro-display industries.

While PμSL technology has been successful in delivering fast fabrication speeds with good resolution, further improvements were still desired. There are three types of resin layer definition methods in PμSL: the first uses a free surface where the layer thickness is defined by the distance between the resin free surface and the sample stage. Due to the slow viscous motion of resins, when the printing area is larger than 1 cm×1 cm, it takes more than a half an hour to define a 10 μm thick resin layer having a viscosity of 50 cPs. The second and third methods use either a transparent membrane or a hard window. The material of the membrane and hard windows in some printing methods is gas permeable, typically oxygen permeable, such as PDMS or Teflon AF, such that the gas permeable material forms the photo polymerization inhibition layer or so called “dead zone” in the CLIPS technology. Due to the oxygen inhibition layer the membrane does not stick to the printing part. However, the inhibition layer is 20 to 50 microns thick, which can be a large source of dimensional error when taken in context with precision 3-D printing, where the tolerance requirement may be at the same level or even smaller. On the other side, due to the thickness of the oxygen inhibition layer, a large flow resistance due to the resin viscosity will significantly reduce the printing speed, especially for dense parts without internal channel connections. Therefore, a zero thickness or very thin oxygen inhibition layer is preferred in precision 3-D printing. As can be appreciated, separation of the membrane and the printing part is very critical.

### SUMMARY

In an aspect of the present disclosure, a 3-D printing system includes a membrane configured to releasably retain a print sample thereon, a membrane release slidably supported on a portion of the membrane, the membrane release comprising a housing defining a cavity within an interior portion thereof, a first roller rotatably supported within a portion of the cavity of the housing, the first roller rotatably disposed on a first portion of the membrane, and a second roller rotatably supported within a portion of the cavity of the housing in spaced relation from the first roller and forming a gap therebetween, the second roller rotatably disposed on a second portion of the membrane, and a vacuum source in fluid communication with the cavity of the housing, wherein the application of a vacuum to the cavity effectuates a corresponding deformation of the membrane between the first and second rollers.

In aspects, the vacuum source may effectuate a vacuum force within the cavity and a resultant deformation of the membrane, wherein deformation of the membrane releases a corresponding portion of the print sample from the membrane.

In other aspects, the first and second rollers may be formed from a material selected from the group consisting of a metallic material, a ceramic material, and combinations thereof.

In certain aspects, the first roller may be formed from a metallic material and the second roller may be formed from a ceramic material.

In other aspects, an exterior portion of at least one of the first and second rollers may include a protective skin disposed thereon.

In aspects, the 3-D printing system may include a buffer chamber disposed within the cavity of the housing, a first portion of the buffer chamber being in fluid communication with the vacuum source and a second portion of the buffer chamber being in fluid communication with the membrane.

In certain aspects, the buffer chamber may include a plurality of apertures defined through a surface thereof disposed adjacent to the membrane to effectuate a uniform pressure drop across the membrane.

In other aspects, the cavity may include an interior profile conforming to an outer profile of the first and second rollers to minimize the flow of air between the interior profile of the cavity and the first and second rollers and direct a resultant vacuum force to the gap between each of the first and second rollers.

In accordance with another aspect of the present disclosure, a 3-D printing system includes a vat configured to retain resin therein, a membrane disposed adjacent an upper surface of the resin, a membrane release slidably supported on a portion of the membrane, the membrane release including a housing defining a cavity within an interior portion thereof, a first roller rotatably supported within a portion of the cavity of the housing, the first roller rotatably disposed on a first portion of the membrane, and a second roller rotatably supported within a portion of the cavity of the housing in spaced relation from the first roller and forming a gap therebetween, the second roller rotatably disposed on a second portion of the membrane, and a vacuum source in fluid communication with the cavity of the housing, wherein the application of a vacuum to the cavity effectuates a corresponding deformation of the membrane between the first and second rollers.

In aspects, the 3-D printing system may include a substrate disposed within the vat and configured to support a printing sample on an upper surface thereof.

In other aspects, the 3-D printing system may include an optical light engine.

In certain aspects, the 3-D printing system may include a lens having an optical axis, the lens operably coupled to the optical light engine.

In other aspects, the 3-D printing system may include a buffer chamber disposed within the cavity of the housing, a first portion of the buffer chamber being in fluid communication with the vacuum source and a second portion of the buffer chamber being in fluid communication with the membrane.

In aspects, the buffer chamber may include a plurality of apertures defined through a surface thereof disposed adjacent to the membrane to effectuate a uniform pressure drop across the membrane.

In certain aspects, the cavity may include an interior profile conforming to an outer profile of the first and second rollers to minimize the flow of air between the interior profile of the cavity and the first and second rollers and direct a resultant vacuum force to the gap between each of the first and second rollers.

In accordance with another aspect of the present disclosure, a method of printing a 3-D sample includes polymerizing a first layer of resin adjacent a lower surface of a membrane, wherein the resin is disposed within an interior cavity of a vat and the membrane is disposed on an upper surface of the resin, effectuating a vacuum within a cavity defined within a housing of a membrane release, the membrane release including a first roller rotatably supported within a portion of the cavity and rotatably disposed on a portion of the membrane and a second roller rotatably supported within a portion of the cavity in spaced relation from the first roller and forming a gap therebetween, the second roller rotatably disposed on a second portion of the membrane, deforming a portion of the membrane disposed adjacent the gap as a result of the vacuum force applied thereto, and advancing the membrane release in a first direction to progressively deform the membrane as the membrane release translates thereacross, wherein advancing the membrane release in the first direction causes the polymerized layer of resin adhered to the lower surface of the membrane to be released therefrom.

In aspects, effectuating the vacuum within the cavity may include effectuating a vacuum within a buffer chamber disposed within a portion of the cavity of the housing of the membrane release.

In other aspects, effectuating the vacuum within the cavity may include drawing air through a plurality of apertures defined through a surface of the buffer chamber, thereby effectuating a uniform pressure drop across the membrane disposed adjacent the gap between the first and second rollers.

In certain aspects, polymerizing the first layer of resin may include projecting an image on the lower surface of the membrane to polymerize resin illuminated by the image.

In aspects, polymerizing the first layer of resin may include projecting the image on the lower surface of the membrane using an optical light engine operably coupled to a lens.

Further, to the extent consistent, any of the aspects described herein may be used in conjunction with any or all the other aspects described herein.

### BRIEF DESCRIPTION OF THE DRAWINGS

Various aspects of the present disclosure are described hereinbelow with reference to the drawings, wherein:

FIG. 1 is a perspective view of a 3-D printing system provided in accordance with the present disclosure;

FIG. 2 is a perspective view of a membrane release of the 3-D printing system of FIG. 1;

FIG. 3 is a bottom view of the membrane release of FIG. 2;

FIG. 4 is a side, cross-sectional view of the membrane release of FIG. 2 illustrating the membrane release selectively coupled to a membrane;

FIG. 5 is a flow chart of a method of printing a 3-D sample provided in accordance with the present disclosure; and

FIG. 6 is a flow diagram of the method of FIG. 5.

### DETAILED DESCRIPTION

The present disclosure is directed to a more reliable method, with greater speed in separating a membrane from a printing part during the PμSL process. However, it is contemplated that the method disclosed herein is not limited to PμSL, but is also valid for any other method using a membrane to assist with 3-D printing. In one non-limiting embodiment, the presently disclosed method uses a dual-roller membrane release combined with a clear membrane and the application of a vacuum. The method not only gently separates the membrane from the printing part in PμSL systems, but also simultaneously inserts a layer of printing material between the membrane and the printing part. At the same time, due to the vacuum, the environmental dusts and dirt contaminating the membrane will be vacuumed to protect the membrane from damage and maintain its optical clarity. Printing materials as used herein refer to material, typically resins, e.g., light curable resins or their mixtures with solid particles, that are used in the industry to print and cure in constructing layers in 3-D printing operations.

The roller membrane release described in the present disclosure has at least one roller which is typically made of metal or ceramic with a 50 μm-100 μm thick surface coating of silicone or rubber. In the present disclosure, a dual-roller membrane release with two parallel rollers with 5 mm diameter and 7.5 mm apart. Typically, the smaller diameter of roller is the better, however, it is limited by the size of the bearings available, as the diameter of the bearing needs to be smaller than that of the roller such that the bearing will not push the membrane away, so a roller around 5 mm will be the limit. The gap between the dual roller is usually between 1.5 to 2 times of the roller diameter to create enough membrane deflection to release the sample. designed for better efficiency is used. An optically clear membrane 50 μm-100 μm thick isolates the rollers from the printing material thereby improving the speed and reliability.

In embodiments, a system having an optical light engine, such as a DLP or LCD with a light source, for projection micro stereolithography or a laser beam with steering mirrors for stereolithography (SLA), a lens defining the magnification of pixel size on the printing surface, a dual-roller membrane release on top of the membrane to release the membrane from the printing sample, three precision stages with 1 um accuracy to control the motion of the printing substrate for supporting the printing sample or the printing optical projection system in the X, Y, and Z directions, and a resin vat under the membrane where the parts are printed. The system is arranged relative to a surface of a substrate, e.g., a sample holder or sample, so that the lens is situated between the surface of the substrate and the light engine and it is gravitationally above the substrate.

In accordance with an embodiment of the present disclosure, the optically clear membrane is made of durable PFA (Perfluoroalkoxy alkanes) or FEP (Fluorinated ethylene propylene). The membrane has a thickness of 50 μm or 100 μm and experiences repeated deformation during the roller membrane release scanning over the membrane. Therefore, deformation durability is critical for the material. Other materials, such as gas permeable Teflon AF from Dupont which can further reduce the separation force due to the oxygen inhibition of photo-polymerization, can also be used.

These and further aspects of the present disclosure are detailed hereinbelow with reference to the drawings in which reference numerals designate identical or corresponding elements in each of the several views.

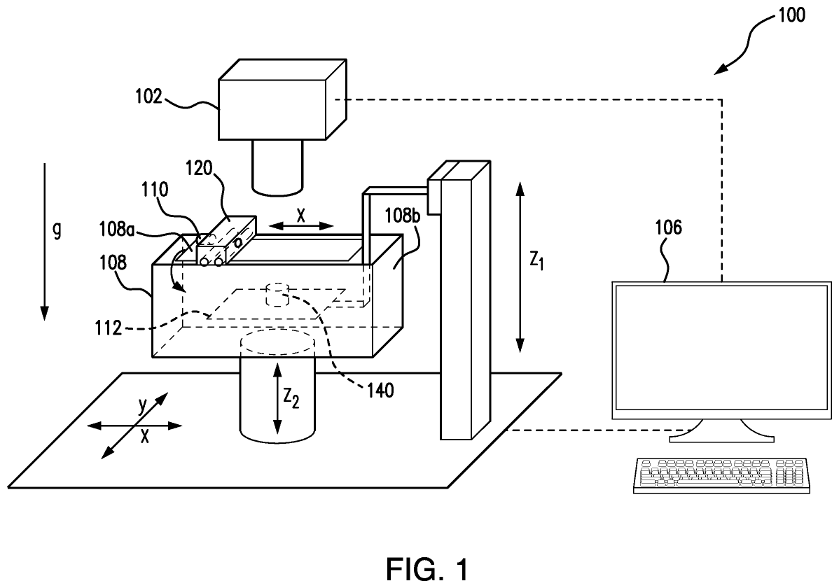

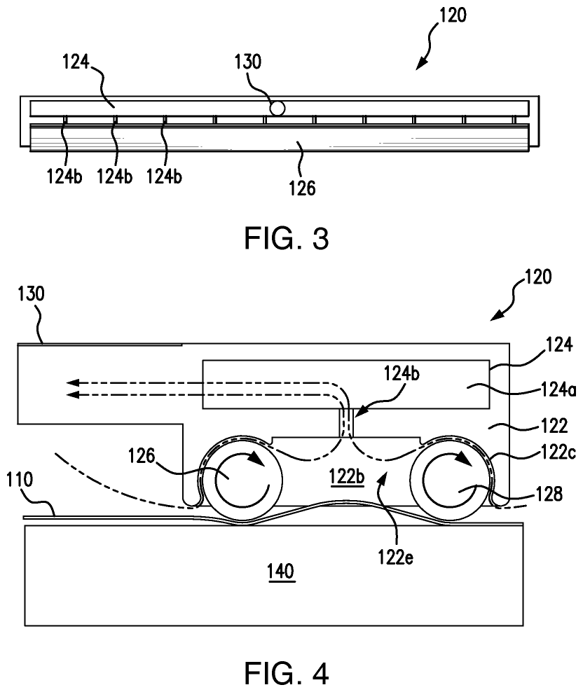

With reference to FIGS. 1-4, a 3-D printing system is disclosed and generally identified by reference numeral 100. The 3-D printing system 100 includes an optical light engine 102, a lens 104, a control computer 106, resin vat 108, a membrane 110, a sample substrate 112, and a membrane release 120.

The optical light engine 102 is in electrical communication with the control computer 106 and the lens 104. The control computer 106 includes a processor (not shown) and a memory (not shown) operably coupled to the processor. The memory stores instructions, which when executed by the processor, cause the processor to transmit an image to the optical light engine 102 and thereafter, be emitted from the lens 104. As described hereinabove, it is contemplated that the optical light engine 102 may be a Digital Light Processing (DLP) projector, a Liquid Crystal Display (LCD) with a light source, amongst others. In embodiments, the optical light engine 102 may include a laser that may include steering mirrors or the like. As can be appreciated, the lens 104 defines the magnification of pixel size on a printing surface.

The resin vat 108 may be any vessel that is able to retain a resin or other substance capable of being used in a stereolithography process therein. In this manner, the resin vat 108 defines a cavity 108a within an interior portion thereof for retaining a resin 108b therein.

The membrane 110 may be an optically clear membrane and may be formed from durable Perfluoroalkoxy Alkane (PFA) or Fluorinated ethylene propylene (FEP), although other suitable materials are also contemplated. The membrane 110 includes a thickness of between 50 μm to 100 μm and may be formed from a resilient material. In this manner, the membrane 110 is subjected to repeated deformation during use, and therefore, deformation durability (over 10 k cycles) is a critical property of the material. In embodiments, the membrane 110 may be formed from a gas permeable Teflon AF, manufactured by DuPont, which can further reduce a separation force from cured resin due to the oxygen inhibition of photo-polymerization.

The sample substrate 112 is a platform that is translatably supported within the cavity 108a of the resin vat 108. In this manner, the platform 112 is translated in a Z-direction towards and away from the lens 104 (e.g., a vertical direction). The platform supports a 3-D printed sample 140 as the resin 108b within the resin vat 108 is polymerized by the image emitted from optical light engine 102 and lens 104. As will be described in further detail hereinbelow, after each layer of the 3-D printed sample 140 is formed, the platform 112 is translated away from the lens 104, a first amount to permit fresh resin 108b to flow between the finished layer of the 3-D printed sample 140 and the membrane 110. It is contemplated that the platform 112 may be formed from any suitable material capable of being used in a stereolithography process and may include any suitable profile, such as circular, square, rectangular, amongst others.

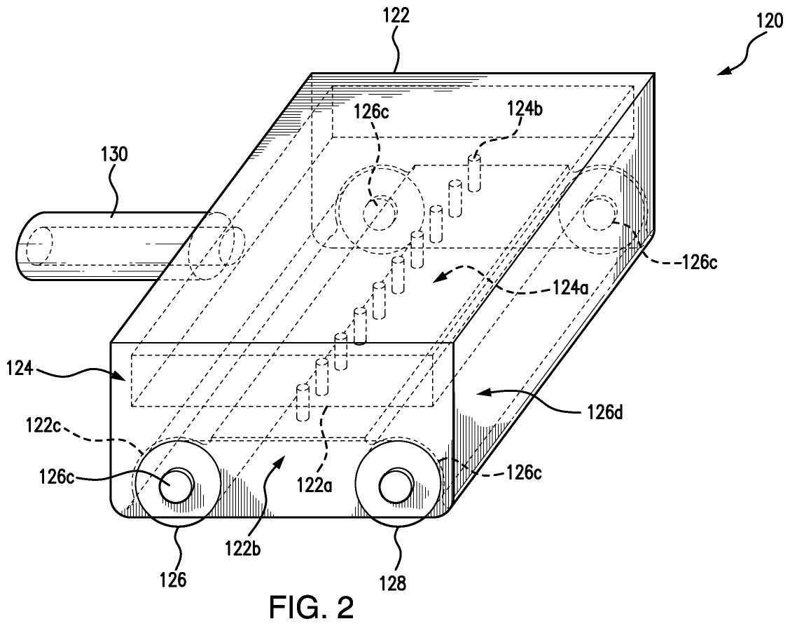

The membrane release 120 (FIGS. 2-4) includes a housing 122, a buffer chamber 124, a first roller 126, a second roller 128, and a vacuum port connection 130. The housing 122 includes a generally rectangular profile, although it is contemplated that any suitable profile may be utilized, such as oval, square, circular, amongst others. The housing 122 includes an interior surface 122a defining a cavity 122b within an interior portion of the housing 122. The interior surface 122a of the housing defines a pair of curvate portions 122c that approximate an outer profile of the first and second rollers 126, 128, as will be described in further detail hereinbelow.

The buffer chamber 124 is disposed within an interior portion of the housing 122 and defined a generally open space or cavity 124a therein. A plurality of apertures 124b is defined through the housing 122 to fluidly couple the cavity 124a of the buffer chamber 124 to the cavity 122b of the housing. In this manner, the plurality of apertures 124b promote an even distribution of vacuum across a length of the housing when a vacuum is applied to the housing 122. In embodiments, the buffer chamber 124 includes an array of 10×500 μm apertures 124b restricting the air flow between the buffer chamber 124 and the cavity 122b of the housing 122. As can be appreciated, the plurality of apertures 124b increases the pressure drop through the housing 122 causes the flow leaving the first and second rollers 126, 128 more uniform along the length of the membrane release 120, and results in better pressure uniformity.

The first and second rollers 126, 128 are substantially similar and therefore only the first roller 126 will be described in detail hereinbelow in the interest of brevity. It is contemplated that the first roller 126 can be made of a metal or a ceramic having a 50 μm-100 μm thick surface coating of silicone or rubber (not shown), although it is contemplated that any suitable material may be utilized, and the first roller may not have a surface coating. As can be appreciated, metals or ceramics are much harder than the membrane 110 and therefore the first roller 126 can cause damage to the surface of the membrane 110, and thus reduce the optical clarity, e.g. optical transparency, of the membrane 110. Therefore, the coating protects the membrane 110 from scratches by the hard metal or ceramic of the first roller 126, while at the same time helping to seal the gas at the contact point between the first roller 126 and membrane 110. It is envisioned that the protective coating of the first roller 126 is either a radially stretched tube or formed during a coating process, such as dip-coating or vapor deposition. As can be appreciated, the protective coating also significantly increases the static friction coefficient between the first roller 126 and the membrane 110 by almost 10 times.

The first roller 126 is rotatably supported within the cavity 122b of the housing by means of a pair of bearings 126c (FIG. 2) that are disposed within a portion of the interior surface 122a of the housing. It is contemplated that the pair of bearings 126c may be a ball bearing, a roller bearing, a bushing, an oil bearing, amongst others. In embodiments, the pair of bearings 126c are 5 mm diameter bearings. As can be appreciated, the protective coating and the pair of bearings 126c guarantee that the first roller 126 only rolls on the membrane 110 without sliding and scratching the membrane 110.

The metal or ceramic core of the first roller 126 maintains the rigidity of the first roller 126 while rolling over the membrane 110 under vacuum to sustain thin gaps (50 um˜100 um) between the first roller 126 and the interior surface 122a of the housing 122. In this manner, the first roller 126 is rotatably supported within the cavity 112b of the housing 122 such that a small gap 126d (FIGS. 2 and 4) is formed between the outer surface of the first roller 126 and the interior surface 122a of the housing 122. In embodiments, the small gap 126d is only large enough to permit free rotation of the first roller 126 within the housing to minimize the amount of air that can flow between the outer surface of the first roller 126 and the interior surface 122a of the housing 122.

As can be appreciated, the small gap 126d chokes the air flow between the interior surface 112a of the housing and the outer surface of the first roller 126 and creates a pressure drop between the top surface and bottom surface of the membrane 110. The first and second rollers 126, 128 cooperate to form a gap (7.5 mm), typically 1.5 to 2 times of the diameter of the roller. 122e (FIG. 4) therebetween that causes a pressure drop 100-200 Pa between the top and bottom surfaces of the membrane 110 that causes the membrane 110 to deform by popping the membrane 110 up 150-200 um and thus peels the membrane 110 off of the 3-D printed sample 140 from one side of the membrane 110 to the other as the first and second rollers 126, 128 move thereacross. It is envisioned that first and second rollers 126, 128 having a diameter of 5 mm with a spacing of 12.5 mm and 104 mm long can be used to cover a 100 mm×100 mm printing area. For a fixed deflection of the membrane typically 200 um, the spacing between the rollers will determine the pressure drop, thus the air flow rate during membrane release. A larger spacing needs less flow to create the same amount of deflection. By considering the form factor of the membrane release, in this invention a center spacing of 12.5 mm, typically 2.5 to 3 times of the roller diameter is used with the gap 7.5 mm, typically 1.5 to 2 times of the roller diameter.

As can be appreciated, the pressure is related to the flow velocity as illustrated by Bernoulli's equation:

$$ρ {v}^{2} + 2 P = Const$$

Here, ρ is the density, v is the flow velocity, and P is the pressure. The equation holds that at a low Mach number along the flow streamlines in a higher velocity area, the pressure is lower. A bottom portion of the membrane 110 experiences uniform atmospheric pressure, but the pressure on the top of the membrane 110 depends on the local flow velocity of air. Therefore, it is important to have a uniform flow rate along the membrane release 120, which, in embodiments, is 104 mm long. In accordance with the present disclosure, the membrane release 120 is connected to vacuum source (not shown) at a middle portion thereof by a vacuum port connection 130 having a diameter of 5 mm, although it is envisioned that any suitable dimension may be utilized.

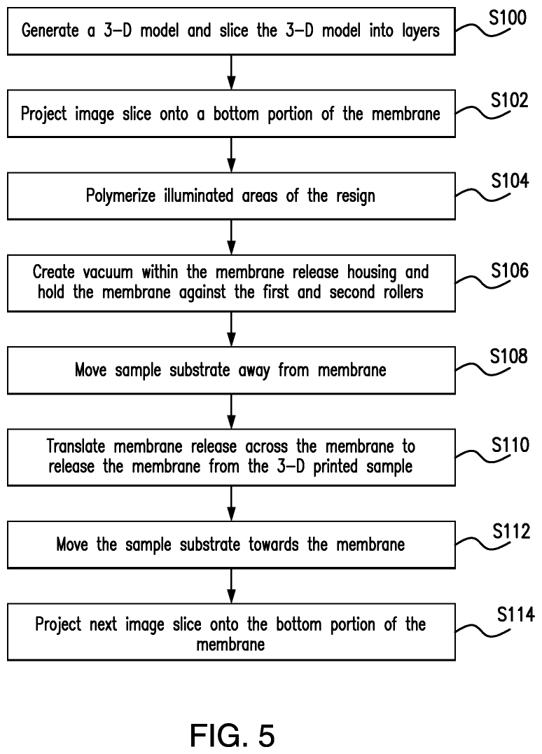

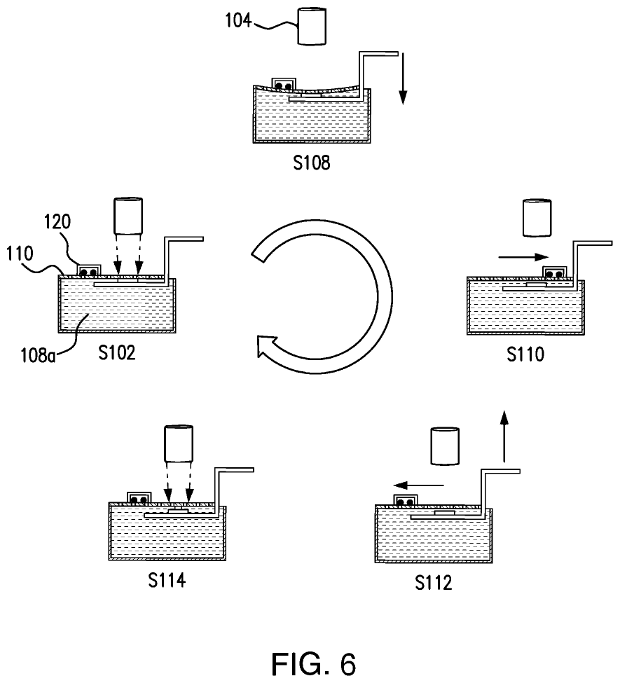

With reference to FIGS. 1-6, a method of printing a 3-D sample is provided and includes generating a 3-D model in the control computer 106 and then slicing the generated 3-D model into a sequence of images, wherein each image represents a layer (e.g., 5 μm-20 μm) of the generated 3-D model (S100). The control computer 106 sends an image to optical light engine 102 and the image is projected through the lens 104 onto a bottom surface (e.g., the wet surface) of the membrane 110 (Step S102). The bright areas of the projected image on the resin immediately beneath the membrane 110 are polymerized whereas the dark areas remain liquid (Step S104). After a first layer is polymerized, the membrane release 120 is parked away from the 3-D printed sample 140, and a vacuum created to hold the membrane 110 against the first and second rollers 126, 128 (Step S106). Thereafter, the sample substrate 112 is caused to move down (e.g., away from the lens 104) 0.5 mm to 2 mm to create space for resin 108b to flow under the membrane 110 behind the first roller 126 in the membrane releasing process (Step S108). The membrane release 120 translates from one side of the membrane 110 to the other at a speed of 5 to 20 mm/s and at the same time, leaves a layer of fresh resin 108b between the membrane 110 and the 3-D printed sample 140 (Step S110), the speed of the membrane release is decided by the velocity of the flow in-between the membrane and the printing sample. The speed should slow enough to allow the fresh resin to fill the gap behind the membrane release. Next, the printing substrate 112 moves up (e.g., towards the lens 104) to define the next layer thickness and the membrane release 120 returns to the original position (Step S112). When the membrane 110 is flattened down due to the membrane tension force or by other coating technology, such as the roller membrane coating technology from Boston Micro Fabrication, the above process is repeated, and the next layer image is projected onto the membrane 110 (Step S114). The above-described steps are repeated until the full 3-D printed sample 140 is replicated in the resin vat 108.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

As used in the drawings and in the description hereinabove, terms such as front, rear, upper, lower, top, bottom, and similar directional terms are used simply for convenience of description and are not intended to limit the disclosure. In the description hereinabove, well-known functions or constructions are not described in detail to avoid obscuring the present disclosure in unnecessary detail.

1. A 3-D printing system, comprising:
a membrane configured to releasably retain a print sample thereon;
a membrane release slidably supported on a portion of the membrane, the membrane release comprising:
a housing defining a cavity within an interior portion thereof;
a first roller rotatably supported within a portion of the cavity of the housing, the first roller rotatably disposed on a first portion of the membrane; and
a second roller rotatably supported within a portion of the cavity of the housing in spaced relation from the first roller and forming a gap therebetween, the second roller rotatably disposed on a second portion of the membrane; and
a vacuum source in fluid communication with the cavity of the housing, wherein the application of a vacuum to the cavity effectuates a corresponding deformation of the membrane between the first and second rollers.

2. The 3-D printing system according to claim 1, wherein the vacuum source effectuates a vacuum force within the cavity and a resultant deformation of the membrane, wherein deformation of the membrane releases a corresponding portion of the print sample from the membrane.

3. The 3-D printing system according to claim 1, wherein the first and second rollers are formed from a material selected from the group consisting of a metallic material, a ceramic material, and combinations thereof.

4. The 3-D printing system according to claim 1, wherein the first roller is formed from a metallic material and the second roller is formed from a ceramic material.

5. The 3-D printing system according to claim 1, wherein an exterior portion of at least one of the first and second rollers includes a protective skin disposed thereon.

6. The 3-D printing system according to claim 1, further comprising a buffer chamber disposed within the cavity of the housing, a first portion of the buffer chamber being in fluid communication with the vacuum source and a second portion of the buffer chamber being in fluid communication with the membrane.

7. The 3-D printing system according to claim 6, wherein the buffer chamber includes a plurality of apertures defined through a surface thereof disposed adjacent to the membrane to effectuate a uniform pressure drop across the membrane.

8. The 3-D printing system according to claim 6, wherein the cavity includes an interior profile conforming to an outer profile of the first and second rollers to minimize the flow of air between the interior profile of the cavity and the first and second rollers and direct a resultant vacuum force to the gap between each of the first and second rollers.

9. A 3-D printing system, comprising:
a vat configured to retain resin therein;
a membrane disposed adjacent an upper surface of the resin;
a membrane release slidably supported on a portion of the membrane, the membrane release comprising:
a housing defining a cavity within an interior portion thereof;
a first roller rotatably supported within a portion of the cavity of the housing, the first roller rotatably disposed on a first portion of the membrane; and
a second roller rotatably supported within a portion of the cavity of the housing in spaced relation from the first roller and forming a gap therebetween, the second roller rotatably disposed on a second portion of the membrane; and
a vacuum source in fluid communication with the cavity of the housing, wherein the application of a vacuum to the cavity effectuates a corresponding deformation of the membrane between the first and second rollers.

10. The 3-D printing system according to claim 9, further comprising a substrate disposed within the vat and configured to support a printing sample on an upper surface thereof.

11. The 3-D printing system according to claim 9, further comprising an optical light engine.

12. The 3-D printing system according to claim 11, further including a lens having an optical axis, the lens operably coupled to the optical light engine.

13. The 3-D printing system according to claim 9, further comprising a buffer chamber disposed within the cavity of the housing, a first portion of the buffer chamber being in fluid communication with the vacuum source and a second portion of the buffer chamber being in fluid communication with the membrane.

14. The 3-D printing system according to claim 13, wherein the buffer chamber includes a plurality of apertures defined through a surface thereof disposed adjacent to the membrane to effectuate a uniform pressure drop across the membrane.

15. The 3-D printing system according to claim 13, wherein the cavity includes an interior profile conforming to an outer profile of the first and second rollers to minimize the flow of air between the interior profile of the cavity and the first and second rollers and direct a resultant vacuum force to the gap between each of the first and second rollers.

16. A method of printing a 3-D sample, comprising:
polymerizing a first layer of resin adjacent to a lower surface of a membrane, wherein the resin is disposed within an interior cavity of a vat and the membrane is disposed on an upper surface of the resin;
effectuating a vacuum within a cavity defined within a housing of a membrane release, the membrane release including a first roller rotatably supported within a portion of the cavity and rotatably disposed on a portion of the membrane and a second roller rotatably supported within a portion of the cavity in spaced relation from the first roller and forming a gap therebetween, the second roller rotatably disposed on a second portion of the membrane;
deforming a portion of the membrane disposed adjacent the gap as a result of the vacuum force applied thereto; and
advancing the membrane release in a first direction to progressively deform the membrane as the membrane release translates thereacross, wherein advancing the membrane release in the first direction causes the polymerized layer of resin adhered to the lower surface of the membrane to be released therefrom.

17. The method of printing a 3-D sample according to claim 16, wherein effectuating the vacuum within the cavity includes effectuating a vacuum within a buffer chamber disposed within a portion of the cavity of the housing of the membrane release.

18. The method of printing a 3-D sample according to claim 17, wherein effectuating the vacuum within the cavity includes drawing air through a plurality of apertures defined through a surface of the buffer chamber, thereby effectuating a uniform pressure drop across the membrane disposed adjacent the gap between the first and second rollers.

19. The method of printing a 3-D sample according to claim 16, wherein polymerizing the first layer of resin includes projecting an image on the lower surface of the membrane to polymerize resin illuminated by the image.

20. The method of printing a 3-D sample according to claim 19, wherein polymerizing the first layer of resin includes projecting the image on the lower surface of the membrane using an optical light engine operably coupled to a lens.
